(19) United States
(12) Patent Application Publication
(10) Pub. No.: US 2003/0230354 A1
(43) Pub. Date: Dec. 18, 2003

(54) Coolant changer machine

(76) Inventor: Larry Randal Roberts, Claremont, CA (US)

Correspondence Address: FULWIDER PATTON LEE & UTECHT, LLP, HOWARD HUGHES CENTER, Tenth Floor, 6060 Center Dr., Los Angeles, CA, 90045, US

(21) Appl. No.: 10/289,125

(22) Filed: Nov. 5, 2002

Related U.S. Application Data
(60) Provisional application No. 60/339,056, filed on Nov. 5, 2001.

(51) Int. Cl. B67C 3/02

(52) U.S. Cl. 141/98

(57) ABSTRACT

The coolant changer machine is a device for transferring radiator coolant fluids, including new, used, and detergent fluids, between storage tanks and an internal combustion engine cooling system. When a vacuum is applied at the radiator cap, fluid is returned to the storage tank, and if the cooling system is hot enough, the fluid will boil can be removed. When air pressure is applied to the top of the storage tank, fluid will flow out of the tank, through the control system and into the engine cooling system. The control system allows for filling the radiator at the cap opening or through the thermostat. The control also allows for circulation through the engine cooling system when the engine thermostat is open to allow complete mixing of flush detergent at elevated temperatures to thereby improve flush performance.

### RELATED APPLICATIONS

This application is based upon provisional patent application Serial No. 60/339,056, filed Nov. 5, 2001.

### BACKGROUND OF THE INVENTION

This invention relates generally to method for removing coolant from an internal combustion engine cooling system, flushing the engine cooling system, and refilling the cooling system.

### SUMMARY OF THE INVENTION

Briefly, and in general terms, the present invention provides for a coolant changer machine for transferring coolant system fluids, including new, used, and detergent fluids, between storage tanks and an internal combustion engine cooling system.

The invention according provides for a coolant changer machine including a first storage tank for waste coolant fluid, with a first conduit for transferring waste coolant fluid from the internal combustion engine cooling system, and having a first adapter for connection to the internal combustion engine cooling system, a second storage tank for flushing fluid, with a second conduit for transferring flushing fluid to the internal combustion engine cooling system, and having a second adapter for connection to the internal combustion engine cooling system, and a third storage tank for new coolant fluid, with a third conduit for transferring new coolant fluid to the internal combustion engine cooling system, and having a third adapter for connection to the internal combustion engine cooling system. A source of air pressure differential is connected between said first, second and third storage tanks and the internal combustion engine coolant system, for controlling flow of fluid through said first, second and third conduits, respectively, and a plurality of valves are provided for controlling said air pressure differential and fluid flow through said first, second and third conduits. In one aspect, the second and third adapters may be connectable to a radiator cap opening of the engine cooling system, or to a thermostat opening of the engine cooling system, and the control system of the coolant changer machine allows for filling the radiator at the cap opening or through the thermostat opening of the engine cooling system, in a reverse flow.

The coolant changer machine advantageously utilizes an air pressure differential between the storage tanks of the coolant changer machine and the engine coolant system, and the operation of the coolant changer machine is controlled by a system of individual valves, hoses, and special connection adapters for each of the various storage tanks that minimizes cross contamination and loss of the fluids. A vacuum is applied at the radiator cap, removing a sufficient amount of coolant fluid from the coolant system to prevent spillage of fluid when an upper radiator hose is removed to install hose adapters of the coolant changer machine at the thermostat and upper radiator connection. Air pressure is applied to the top of a coolant storage tank, causing coolant fluid to flow out of the bottom of the tank opening, through the control system and into the engine cooling system.

The control system automatically selects the appropriate return for each fill. When FLUSH detergent fills the engine, waste coolant, displaced from the engine, is returned to the WASTE tank. When NEW coolant fills the engine, FLUSH detergent is displaced from the engine and returned to the FLUSH tank. This leaves the FLUSH tank ready for another flush cycle with the same fluid if so desired. The control system also allows for circulation of the engine cooling system when the engine thermostat is open to allow complete mixing of flush detergent at elevated temperatures, thereby improving flush performance.

These and other aspects and advantages of the invention will become apparent from the following detailed description and the accompanying drawings, which illustrate by way of example the features of the invention.

### BRIEF DESCRIPTION OF THE DRAWINGS

FIG. 1 is a chart of valve handle positions and settings for the steps for operation of the coolant changer machine of the invention.

FIG. 2 is a top plan view of a coolant changer machine according to the invention illustrating the array of valve handles for control of the coolant changer machine.

FIG. 3 is a schematic diagram of the coolant changer machine of the invention, identifying the components and valve settings for operation of the coolant changer machine of the invention.

FIG. 4 is a front perspective view of the coolant changer machine of the invention.

FIG. 5 is a rear perspective view of the coolant changer machine of the invention.

### DETAILED DESCRIPTION OF THE PREFERRED EMBODIMENT

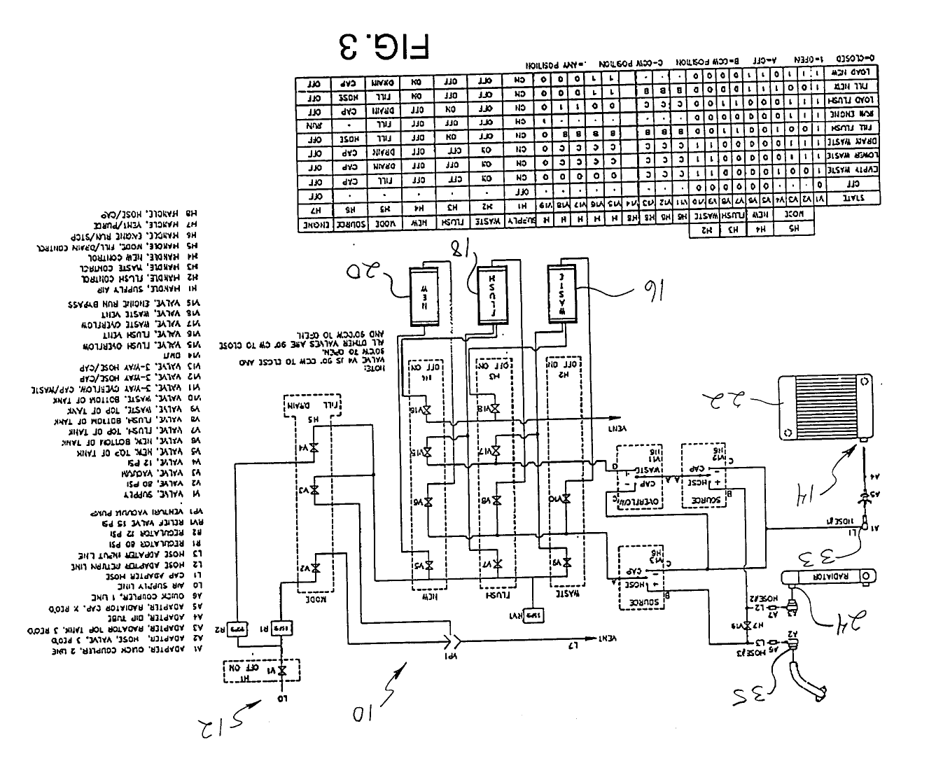

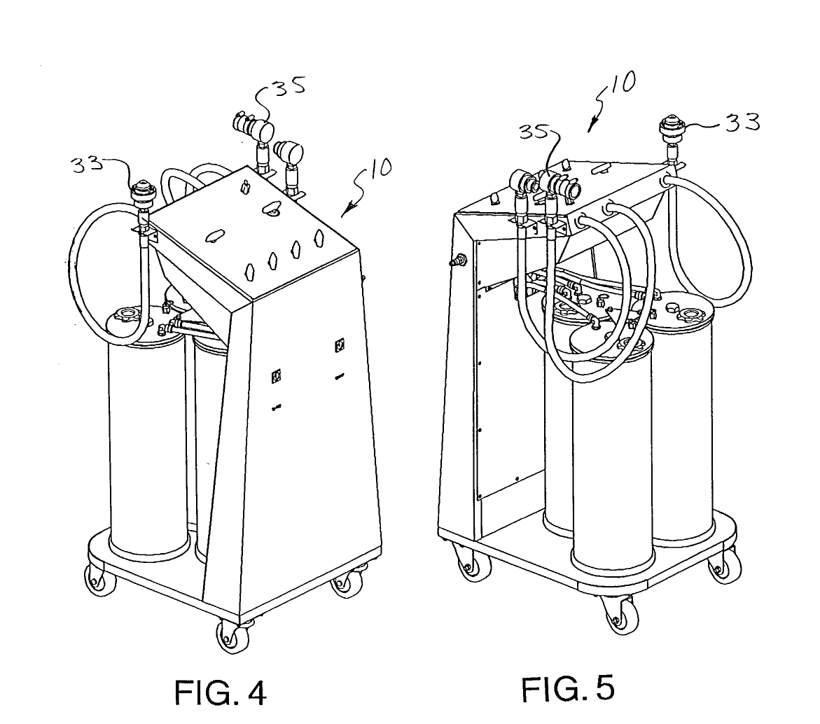

As is illustrated in the drawings, the invention is embodied in a coolant changer machine for transferring coolant system fluids, including new, used, and detergent fluids, between storage tanks and an internal combustion engine cooling system. Referring to FIGS. 3, 4 and 5, the coolant changer machine 10 of the invention utilizes differential air pressure to transfer fluid between the storage tanks and the coolant system which is controlled by a system of valves, hoses, and special connection adapters. The source of differential air pressure 12, shown in FIG. 3, is typically an external source of compressed air, as well as a venturi jet pump used as a source of vacuum for pressures lower than atmospheric pressure. When a vacuum is applied at the radiator cap 14, atmospheric pressure causes the cooling system hoses to collapse. The fluid in these hoses is displaced and is allowed to return to the waste storage tank 16 which is under vacuum. If the cooling system is hot enough, the fluid inside the engine will begin to boil and additional fluid can be removed. However, only enough fluid needs to be removed to prevent spillage of fluid when the upper radiator hose of the engine cooling system is removed, when installing the hose adapters at the thermostat and upper radiator connection.

When air pressure is applied to the top of the flush storage tank 18 or new coolant storage tank 20, fluid will flow out of the bottom of the tank opening, through the control system and into the engine cooling system 22. The control system allows selection of filling the radiator at the cap opening 24 or through the thermostat (not shown) of the engine cooling system in a reverse flow. When filling the engine cooling system in reverse flow, fluid in the engine is displaced under pressure and is allowed by the controlling system to return to a separate vented storage tank such as storage tank 16. This process does not require an open thermostat and will work with cold fluids. The control system automatically selects the appropriate return for each fill. When FLUSH detergent from the FLUSH storage tank fills the engine, waste coolant, displaced from the engine, is returned to the WASTE tank. When NEW coolant from the NEW coolant storage tank fills the engine, FLUSH detergent is displaced from the engine and returned to the FLUSH tank. This leaves the FLUSH tank ready for another flush cycle with the same fluid if so desired.

The control also allows for circulation of the engine cooling system when the engine thermostat is open to allow complete mixing of flush detergent at elevated temperatures, thereby improving flush performance.

The control system uses two types of valves. There are typically 15 ball valves and 3 three-way ball valves. The three-way valves are connected to a single handle using a pulley and timing belt system. The 15 ball valves are in several groups of 2, 3 and 4 valves. Each group is connected to a single handle using a fork and lever mechanism.

VALVE HANDLES

| | |
|---|---|
| Air Supply | The Air Supply valve handle 30 is used to turn main air |
| | supply ON and OFF. |
| Source | The Source valve handle 32 is used to control redirection |
| | of input and output of fluid from the Radiator Cap Adapter |
| | 33 to the Hose Adapter 35. |
| Engine | The Engine valve handle 34 controls circulation of the |
| | engine coolant and allows engine cooling system to |
| | circulate while the engine is running and the thermostat |
| | is open during the flush engine run cycle. |
| Waste | The Waste valve handle 36 opens path from Waste storage |
| | tank to Source Cap or Hose 38. |
| Flush | The Flush valve handle 40 controls the path from the Flush |
| | storage tank to the Source Cap or the Hose and opens the |
| | path for return to Waste tank and opens vent to waste tank. |
| New | The New valve handle 42 controls the path from New |
| | storage tank to Source Cap or Hose and opens the path for |
| | return to Flush tank and opens vent to Flush tank. |
| Mode | The Mode valve handle 44 selects the mode of operation, |
| | such as Drain or Fill. In the Drain position, high pressure |
| | (80 psi) is applied to the venturi vacuum pump and the |
| | vacuum is applied to the Waste, Flush, and New valve |
| | systems. In the Fill position, Low pressure (20 psi) is |
| | applied to the Waste, Flush and New valve system. |

Steps to Complete Extract Flush and Exchange

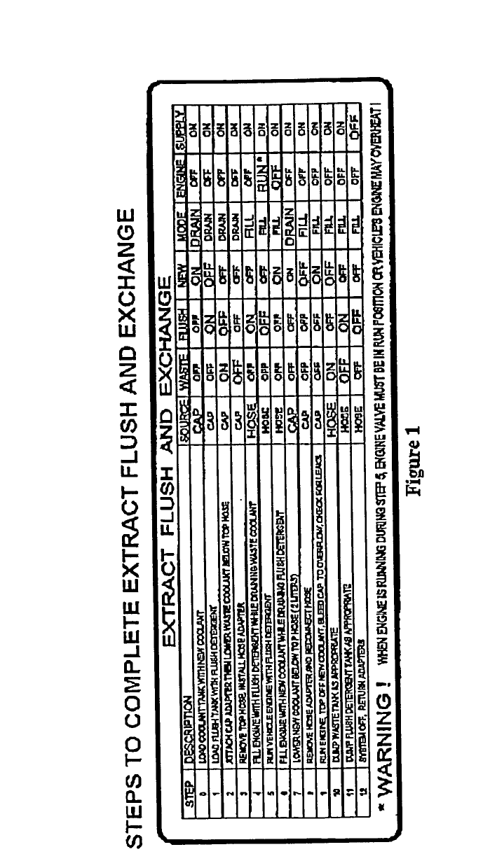

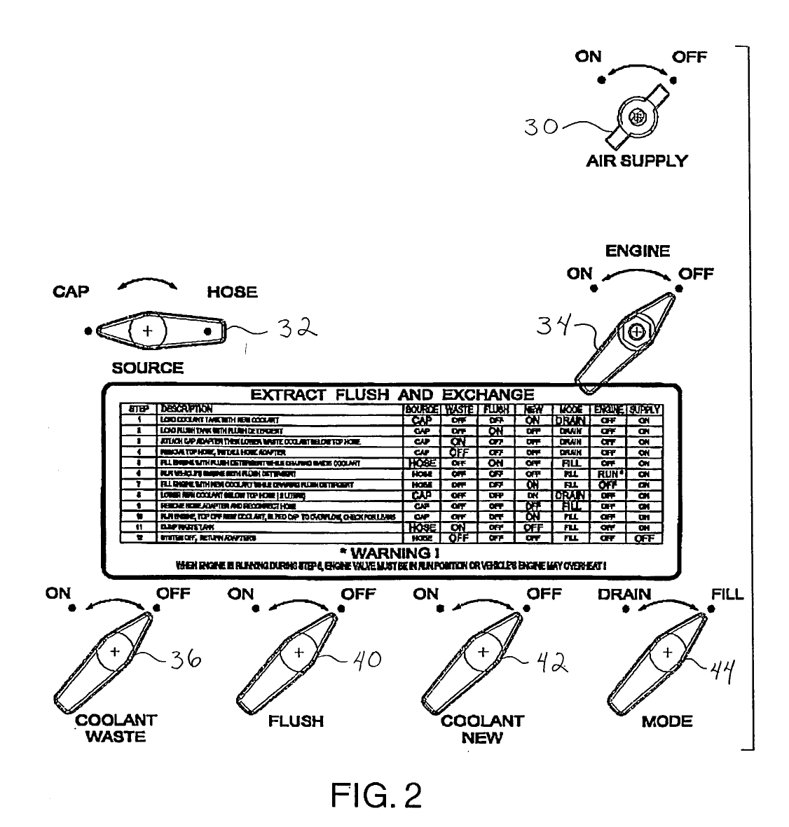

The steps for operation of the system of the invention are discussed below, with reference to FIGS. 1-3.

Step 0

Load Coolant Tank with New Coolant

With a Dip Tube adapter connected to the Cap Adapter Hose, set valve handles to the positions indicated in FIG. 1. Place the dip tube into the new coolant supply container. Turn Mode handle to OFF position to stop suction when supply container is empty. An alternate method is to remove Cap on New Coolant Tank and pour new coolant directly into the storage tank. Repeat until New Coolant Tank is filled with the appropriate amount of coolant. Replace cap.

Step 1

Load Flush Tank with Flush Detergent

With a Dip Tube adapter connected to the Cap Adapter Hose, set valve handles to the positions indicated in FIG. 1. Place the dip tube into the flush detergent supply container. Turn Mode handle to OFF position to stop suction when supply container is empty. An alternate method is to remove Cap on Flush Detergent Tank and pour Flush Detergent directly into the storage tank. Fill with water. Repeat until Flush Detergent Tank is filled with the appropriate amount of flush solution. Replace cap.

Step 2

Attach Cap Adapter then Lower Waste Coolant Below Top Hose

Select the appropriate size Cap Adapter and attach to Hose #1. If the engine cooling system is hot, the coolant may be under pressure. Squeeze the upper radiator hose. If the hose is firm the coolant system is under pressure. Slowly rotate the radiator cap. If the system is pressurized, the coolant will flow into the overflow tank. When the overflow tank stops bubbling, the engine cooling system will no longer be under pressure and the radiator cap may be removed. After removing the radiator cap, attach the cap adapter to the radiator. Set the valve handle to the positions indicated in FIG. 1. Remove waste coolant until the level of coolant in the radiator is below the top hose connection on the radiator. This is usually about 2 or 3 liters of fluid. Observe the scale on the side of the Waste Tank. Turn the Waste Coolant handle to OFF and the Mode handle to FILL when enough waste coolant is removed.

Step 3

Remove Top Hose, Install Hose Adapter

After turning the valve handle to the positions indicated in FIG. 1, remove the hose clamp and disconnect the upper radiator hose from the top of the radiator.

Select the appropriate size Hose Adapter and attach to Hose #2 and attach to the top radiator opening with a hose clamp. Attach the other Hose Adapter to Hose #3 and attach directly to the top radiator hose with another hose clamp.

Step 4

Fill Engine with Flush Detergent while Draining Waste Coolant

Set valve handles to the positions indicated in FIG. 1. Flush Detergent will flow into the top radiator hose, through the engine thermostat. The Waste Coolant in the engine is displaced by the Flush Detergent and the Waste Coolant flows into the Waste Tank. If the capacity of the engine cooling system is known, the same volume of Flush Detergent can be monitored filling the cooling system using the scale on the side of the Flush Detergent Tank. Turn the Flush handle to OFF. Alternatively, when the blue Flush detergent is seen in return Hose #2, turn the Flush handle to OFF.

Referring to FIG. 3, showing a schematic diagram of the control valve system of the coolant changer machine of the invention, when the Air supply valve V1 is on, line pressure is supplied to both regulators R1 and R2. The MODE handle H5 in the FILL position leaves V2 off, V3 off and V4 on. Since V2 is off, no air flows to the venturi vacuum pump VP1. Since V3 is off, the vacuum source is shut off from the WASTE-FLUSH-NEW manifold. Since V4 is on, 20 psi air flows from the low pressure regulator R2 to the WASTE-FLUSH-NEW manifold. In the WASTE-FLUSH-NEW manifold, H3 is in the ON position which leaves V5 and V9 off and V7 on. This means only the Flush Tank is pressurized. H2 and H4 are in the OFF position which leaves V9, V10, V5, V6, V15, and V16 off. Since V16 is off and V8 is on, the Flush Detergent flows from the Flush Tank to the source selector valve V13. Since the source handle is in the HOSE position, fluid flows from V13A to V13B and into Hose #3 and through the Hose Adapter, the thermostat, and the engine block. Waste coolant in the engine is displaced under pressure and flows out of the radiator at Hose #2. Fluid then flows into source selector valve at V12B, exits V12A, then enters overflow control valve at V11A and exits V11B. Since V9 and V11 are off and V17 and V18 are on, fluid flows into the vented Waste Tank.

Step 5

Run Vehicle Engine with Flush Detergent

Set valve handles to the positions indicated in FIG. 1. Start the vehicle engine. With the ENGINE valve in the RUN position, the Flush Detergent will circulate in the engine cooling system after the thermostat opens. The open thermostat can be observed when the temperature of the Hose Adapter connected to Hose #2 reaches 195° F. See the temperature indicator on the Hose Adapter. If the time required to open the thermostat is 10 minutes, continue running the engine another 10 minutes to ensure all of the Flush Detergent is at normal operating temperature. Turn the vehicle engine off. When the engine is running during this step, the engine valve must be in the Run position or the vehicle's engine may overheat.

Step 6

Fill Engine with new Coolant while Draining Flush Detergent.

Set valve handles to the positions indicated in FIG. 1. New Coolant will flow into the top radiator hose, through the engine thermostat. The Flush Detergent in the engine is displaced by the New Coolant and the used Flush Detergent flows into the Flush Tank. If the capacity of the engine cooling system is known, the same volume of New Coolant can be monitored filling the cooling system using the scale on the side of the New Coolant Tank. Turn the New Coolant handle to OFF. Alternatively, when the New Coolant is seen in the return Hose #2, turn the New Coolant handle to OFF.

Step 7

Lower New Coolant Below Top Hose (2 Liters).

Set valve handles to the positions indicated in FIG. 1. Remove enough coolant to lower the level of coolant in the radiator just below the top radiator hose connection. This is usually about 2 liters of fluid. New Coolant is removed in this step and returned to the New Coolant Tank. Monitor the amount of fluid removed using the scale on the side of the New Coolant Tank. Turn the New Coolant handle to OFF and the Mode handle to Fill.

Step 8

Remove Hose Adapter and Reconnect the Hose

With valve handles set to the positions indicated in FIG. 1, remove the Hose Adapters and reconnect the top radiator hose to the radiator with the original hose clamp.

Step 9

Run Engine, Top Off New Coolant, Bleed Cap to Overflow, Check for Leaks

Set valve handles to the positions indicated in FIG. 1. Start the vehicle's engine. When New Coolant stops flowing into the engine, check hoses for leaks. Slowly loosen the Cap Adapter handle until the coolant starts flowing into the overflow tank on the vehicle. Monitor the level in the overflow tank and turn the New Coolant handle to OFF when the level in the overflow tank is at the COLD level mark. Turn the vehicle's engine OFF. Remove the Cap Adapter and check the level of fluid in the radiator. Additional New Coolant may be added as needed by inserting the neck of the Cap Adapter into the radiator and metering in a small amount of New Coolant using the New Coolant handle.

Step 10

Dump Waste Tank as Appropriate

Remove the Hose Adapter from Hose #3. Connect or place Hose #3 into a bulk storage container for waste coolant. Set valve handles to the positions indicated in FIG. 1. The Waste Coolant will flow from the Waste Coolant Tank into the bulk storage container. Turn the Waste handle to OFF when the Waste Coolant Tank is empty.

Step 111

Dump Flush Tank as Appropriate

To dump used Flush Detergent, connect or place Hose #3 into a bulk storage container for waste coolant. Set valve handles to the positions indicated in FIG. 1. The used Flush Detergent will flow from the Flush Detergent Tank into the bulk storage container. Turn the Flush Coolant handle to OFF when the Flush Detergent Tank is empty.

Step 12

System Off, Return Hose Adapters

Set valve handles to the positions indicated in FIG. 1. Disconnect and return all Cap and Hose Adapters to the storage shelf.

It will be apparent from the foregoing that while particular forms of the invention have been illustrated and described, various modifications can be made without departing from the spirit and scope of the invention.

What is claimed is:

1. A coolant changer machine for changing coolant in and flushing an internal combustion engine cooling system, comprising:
a first storage tank for waste coolant fluid;
a first conduit for transferring waste coolant fluid from the internal combustion engine cooling system, the first conduit connected to the first storage tank and having a first adapter for connection to the internal combustion engine cooling system;
a second storage tank for flushing fluid;
a second conduit for transferring flushing fluid to the internal combustion engine cooling system, the second conduit connected to the second storage tank and having a second adapter for connection to the internal combustion engine cooling system;
a third storage tank for new coolant fluid;
a third conduit for transferring new coolant fluid to the internal combustion engine cooling system, the third conduit connected to the third storage tank and having a third adapter for connection to the internal combustion engine cooling system;
a source of air pressure differential connected between said first, second and third storage tanks and the internal combustion engine coolant system, for controlling flow of fluid through said first, second and third conduits, respectively; and
a plurality of valves for controlling said air pressure differential and fluid flow through said first, second and third conduits.

2. The coolant changer machine of claim 1, wherein said second adapter comprises an adapter connectable to a radiator cap opening of the engine cooling system.

3. The coolant changer machine of claim 1, wherein said second adapter comprises an adapter connectable to a thermostat opening of the engine cooling system.

4. The coolant changer machine of claim 1, wherein said third adapter comprises an adapter connectable to a radiator cap opening of the engine cooling system.

5 The coolant changer machine of claim 1, wherein said third adapter comprises an adapter connectable to a thermostat opening of the engine cooling system.
